(19) United States
(12) Patent Application Publication
(10) Pub. No.: US 2026/0309254 A1
(43) Pub. Date: Oct. 8, 2026

(54) COMPOSITE LAYER AND METHOD THEREOF

(71) Applicant: Baker Hughes Energy Technology UK Limited, Bristol (GB)

(72) Inventors: Fabio De Souza PIRES, Newcastle-Upon-Tyne Tyne and Wear (GB); Andre Leao MACEDO, Newcastle-Upon-Tyne Tyne and Wear (GB); Richard Alasdair CLEMENTS, Newcastle-Upon-Tyne Tyne and Wear (GB); Andrew Peter ROBERTS, Newcastle-Upon-Tyne Tyne and Wear (GB); Colin William RUSSELL, Newcastle-Upon-Tyne Tyne and Wear (GB); Garry Ian KENDALL, Newcastle-Upon-Tyne Tyne and Wear (GB)

(21) Appl. No.: 18/998,567

(22) PCT Filed: Jul. 28, 2023
(86) PCT No.: PCT/EP2023/025355

§ 371 Date: Jan. 27, 2025

(30) Foreign Application Priority Data
Jul. 29, 2022 (GB) 2211136.3

(51) Int. Cl. F16L 11/08; B32B 1/08; B32B 5/02; B32B 15/14; F16L 11/12

(52) U.S. Cl. CPC F16L 11/081; B32B 1/08; B32B 5/02; B32B 15/14; F16L 11/12; B32B 2307/7242; B32B 2307/7376; B32B 2597/00

(57) ABSTRACT

A flexible pipe body for transporting production fluids, and a method of manufacturing a flexible pipe body are provided. The flexible pipe body comprises: a helically wound metallic armour layer; and a composite tape layer for reducing fluid permeation of the production fluids to a pipe annulus, wherein the composite tape layer comprises a plurality of fibres; wherein the composite tape layer is positioned radially inward of the helically wound metallic armour layer.

### TECHNICAL FIELD

The present invention relates to a flexible pipe body including a composite tape layer and a method of manufacturing said flexible pipe body. In particular, but not exclusively, the present invention relates to a flexible pipe body including a composite tape layer for reducing fluid permeation.

### BACKGROUND

Flexible pipe is particularly useful in connecting a sub-sea location (which may be deep underwater) to a sea level location. The pipe may have an internal diameter of typically up to around 0.6 metres (e.g. diameters may range from 0.05 m up to 0.6 m). Flexible pipe is generally formed as an assembly of a flexible pipe body and one or more end fittings. The flexible pipe body is typically formed as a combination of layered materials that form a pressure-containing conduit. The pipe structure allows large deflections without causing bending stresses that impair the pipe's functionality over its lifetime. The flexible pipe body is generally built up as a combined structure including polymer, and/or metallic, and/or composite layers. For example, a flexible pipe body may include polymer and metal layers, or polymer and composite layers, or polymer, metal and composite layers.

API Recommended Practice 17B provides guidelines for the design, analysis, manufacture, testing, installation, and operation of flexible pipes and flexible pipe systems for onshore, subsea and marine applications. API Specification 17J titled “Specification for Unbonded Flexible Pipe” defines the technical requirements for safe, dimensionally and functionally interchangeable flexible pipes that are designed and manufactured to uniform standards and criteria.

Flexible pipe body typically includes a fluid-retaining layer (known as a barrier layer or liner) formed generally as a polymer sheath or pressure sheath. Such a layer operates as a primary fluid retaining layer. To prevent rupture of such a layer caused by the pressure of the transported fluid, an interlocked wire layer (known as a pressure armour layer) is often located radially outwards of the fluid-retaining layer. A typical flexible pipe body includes one or more armour layers, optionally including a pressure armour layer. The primary load on such layers is formed from radial forces. Pressure armour layers often have a specific cross section profile to interlock so as to be able to maintain and absorb radial forces resulting from outer or inner pressure on the pipe. The cross-sectional profile of the wound wires which thus prevent the pipe from collapsing or bursting as a result of pressure are sometimes called pressure-resistant profiles. When armour layers are formed from helically wound wires forming hoop components, the radial forces from inner or outer pressure on the pipe cause the hoop components to expand or contract, putting respectively tensile or compressive loads on the wires.

Certain known examples of pressure armour layers may be provided as a tape or composite tape form, wrapped or wound around radially inward layers. The tape is orientated to ensure its longitudinal strength is arranged circumferentially, or substantially circumferentially around the axis of the flexible pipe body. Thus, the tape is wrapped or wound with a lay angle relative to the axis of between 80° and 90° to provide a pressure armour layer formed from tape. In this way, tape forms a pressure armour layer which is able to maintain and absorb radial forces resulting from pressure in the pipe.

One or more tensile armour layers may be positioned radially outward of a pressure armour layer(s). Tensile armour is used to sustain tensile loads and internal pressure. The tensile armour layer is often formed from a plurality of wires (to impart strength to the layer) that are located over an inner layer and are helically wound along the length of the pipe. The tensile armour layers are often metallic layers, formed from carbon steel for example. The tensile armour layers may alternatively be composite tendons, of a matrix material reinforced with suitable fibres, for instance of glass, carbon, aramid, basalt, or metal.

Flexible pipe is utilised to transport production fluids, such as oil and/or gas and/or water, from one location to another. As used herein “fluid” includes both liquid and gases substances. When a production fluid is conveyed through a flexible pipe, fluids such as carbon dioxide and hydrogen sulphide gases, for example, can permeate the inner most layers of the flexible pipe body (for example the internal pressure sheath). As used herein, permeation, particularly permeation of a fluid through a layer of a flexible pipe, may include both transmission of the fluid through a body of the layer as well as leakage of the fluid through discontinuities or gaps in the layer, the particular meaning being readily apparent from the context of the accompanying description.

These fluids then accumulate in the pipe annulus, a layer provided at, or substantially at, a radially outermost portion of the flexible pipe body. This may result in a corrosive environment, in particular when associated with water present in the annulus, for example during an annulus flooding event. The corrosive environment is known to lead to pipe failure due to stress corrosion cracking of the metallic pipe layers, particularly those metallic layers used within armour layers. Furthermore, a build-up of annulus fluids can cause over pressurization and mechanical failure of the flexible pipe.

It is an aim of certain examples of the present invention to solve, mitigate or obviate, at least partly, at least one of the problems and/or disadvantages associated with the prior art. Certain examples aim to provide at least one of the advantages described below.

### SUMMARY OF THE INVENTION

The invention is set out in the appended claims.

According to a first aspect of the invention there is provided a flexible pipe body for transporting production fluids, the flexible pipe body comprising:
a helically wound metallic armour layer; and
a composite tape layer for reducing fluid permeation from the production fluids to the pipe annulus, wherein the composite tape layer comprises a plurality of fibres;
wherein the composite tape layer is positioned radially inward of the helically wound metallic armour layer.

By providing, firstly, a composite tape layer that acts to reduce fluid permeation in combination, secondly, with a metallic armour layer, the flexibility of the flexible pipe body is increased without compromising hoop strength or fluid barrier properties. The helically wound metallic armour layer acts as the main contributor to the hoop strength of the flexible pipe body. This allows for the composite tape layer to act predominantly as a shielding layer to restrict fluid permeation through the flexible pipe body i.e. from the production fluids to the pipe annulus. As such, the dimensions of the composite tape and the lay angles of the composite tape layer can be reduced compared to typical composite pressure armour layers.

In addition, the properties of the composite tape and/or the composite tape layer may be adapted to optimise its fluid barrier properties. Either, or both, of the fibres and the polymer matrix within a composite tape may be adapted to reduce the fluid permeability of the composite tape layer via transmission through the body of the composite tape forming the composite tape layer. For example, as set out herein, the fibre density may be increased to increase the tortuosity of the composite tape layer. As a further example the polymer matrix may be selected from a material with low permeability, particularly via transmission, such as, but not limited to, PVDF, PEEK, and PEKK. In these ways, the composite tape layer provides a permeation barrier to inhibit or reduce corrosion of any metallic armour layer provided radially outwards thereof.

Furthermore, the arrangement provides improved adaptability of the flexible pipe body. In other words, the arrangement provides a greater number of options for design and manufacture of the flexible pipe body. The combination of layers provides the ability to adapt the composite tape layer according to the specific permeation requirements of one or more production fluids contained while providing increased flexibility.

Suitably, the helically wound metallic armour layer is a pressure armour layer or a tensile armour layer.

Suitably, the composite tape layer is positioned radially inward of and directly adjacent to the helically wound metallic armour layer.

Suitably, the flexible pipe body further includes an internal pressure sheath. The internal pressure sheath may be positioned radially inward of, or radially outward of, the composite tape layer.

Suitably, the flexible pipe body includes at least one sacrificial layer radially adjacent the composite tape layer. The flexible pipe body may include a sacrificial layer positioned radially inward of the composite tape layer. Additionally, or alternatively, the flexible pipe body includes a sacrificial layer positioned radially outward of the composite tape layer. Thus, the flexible pipe body may include two sacrificial layers each radially adjacent the composite tape layer such that the composite tape layer is arranged therebetween. The composite tape layer may therefore be sandwiched between two sacrificial layers.

The sacrificial layer(s) advantageously reduce or prevent direct contact of the composite layer with the other structural layers of the pipe, thereby helping to reduce wearing of the composite layer. Furthermore, contact pressure between the sacrificial layer(s) and metallic layers (i.e. the metallic armour layers) may further improves shielding against fluid permeation through the flexible pipe body.

Suitably, the sacrificial layer(s) are polymeric layers. In this way, the sacrificial layer may provide a further advantage of providing a flexible pipe body with a synergistic benefit of a tortuous path around fibres embedded in the matrix of the composite tape as well as a shielding effect between the contact surfaces of the sacrificial layer and the helically wound metallic armour layer. Thus, fluids are particularly limited from permeating into the metallic armour layer.

Suitably, the sacrificial layer(s) are polymeric layers comprising one or more of PEEK, PEKK, PVDF, PFA, Polyurea, Polyamide, polyester, or polyolefin such as polyethylene or polypropylene. Sacrificial layer(s) may also be polymeric layers comprising filler materials, including mineral additives, short fibres, or a second polymeric material phase such as an elastomer or a fluoropolymer. Suitably, the second polymeric material phase comprises PTFE.

Suitably, the composite tape layer and the sacrificial layer are at least partially bonded to one another using an adhesive. Alternatively, the composite tape layer and the sacrificial layer may be at least partially bonded to one another using a melt consolidation or a melt bond, using heat and/or pressure from rollers. A melt consolidation or a melt bond is a bond without an adhesive.

Suitably the plurality of fibres in the composite tape layer are continuous fibres. That is, the continuous fibres may include bundles or tows of fibres, or individual fibres wherein each fibre is aligned in the length direction of the composite tape of the composite tape layer. Optionally, a bundle or tow of fibres may be straight or twisted together.

Suitably, the plurality of fibres in the composite tape layer may include carbon fibres, glass fibres, basalt fibres, tensilized polymer fibres, metal wires, or any combination thereof. These fibres may be impermeable.

Suitably, the composite tape of the composite tape layer includes a lay angle relative to the pipe axis of less than 80°. That is, the angle relative to the longitudinal axis of the flexible pipe body at which the composite tape is wound onto, or applied to, the flexible pipe body to form the composite tape layer is less than 80°. Suitably, the composite tape of the composite tape layer includes a lay angle relative to the pipe axis of from 20° to less than 80°, more suitably of from 40° to less than 80°. Most suitably the composite tape of the composite tape layer includes a lay angle relative to the pipe axis of from 40° to less than 60°. By reducing the lay angle of the composite tape the composite tape layer becomes more flexible. The flexible pipe body including the composite tape layer is thereby also more flexible.

Suitably, the composite tape layer includes a plurality of sub-layers of composite tape. For example, a first composite tape layer and a second composite tape layer.

Suitably, the composite tape layer has a region of overlap between adjacent tape wraps of composite tape, such that each tape wrap at least partially covers a laterally adjacent tape wrap. Typically, laterally adjacent tape wraps of the composite tape are provided with the same lay angle. The overlaps may therefore reduce permeation of fluid through the composite tape layer by reducing or removing gaps between adjacent tape wraps. Particularly, leakage of fluid via discontinuities between laterally adjacent tape wraps, or between radially adjacent sub-layers of tape wraps is thereby reduced.

Suitably, the composite tape layer is consolidated with adjacent tape wraps and/or adjacent sub-layers of composite tape so the adjacent composite tapes are at least partially bonded together. For example, a first tape wrap is bonded to a laterally adjacent second tape wrap where the first tape wrap partially covers the second tape wrap.

Suitably, the plurality of sub-layers have different lay angles from each other. That is a first composite tape layer has a first lay angle and a second composite tape layer has a second lay angle, wherein the first lay angle is different to the second lay angle. In other examples the sub-layers, particularly the composite tape layers therein, may have the same lay angle as one another.

Suitably, a first composite tape layer may be wound at a first lay angle to the axis of the flexible pipe, and a second composite tape layer may be counter wound at a second lay angle. Optionally, the first lay angle of the wound first composite tape layer may be the same as the second lay angle of the counter wound second composite tape layer. In this way permeation of fluid through the composite tape layer, particularly leakage though discontinuities, is reduced by removing gaps between successive wraps of composite tape sub-layers.

Suitably, the composite tape layer is less than 5 mm thick. The metallic armour layer, provided as one or both of a pressure armour layer and a tensile armour layer, may provide the majority of the hoop strength reinforcement. Advantageously, the composite layer may therefore be a thinner layer than a typical composite tape layer used to provide hoop strength. Accordingly, the material cost of the flexible pipe body may be reduced. Suitably, the reduction in permeation resulting from the composite tape layer may allow a higher strength metallic material to be used in the metallic armour layer, leading to smaller and lighter cross-sections for the wires in such layers, also reducing cost and pipe weight.

Suitably, the composite tape layer includes a low permeation polymer matrix so as to minimise transmission of fluid through the body of the composite tape. The low permeation polymer matrix has a permeation coefficient for CO₂ of less than 50.00E⁻⁶cm³·(STP)·cm/cm²·s·bar when tested at 100°C., 8 bar pressure, in accordance with ISO 2556 and ISO 15105-1. Preferably, the permeation coefficient for CO₂ is less than 4.00E⁻⁷ cm³·(STP)·cm/cm²·s. bar, ideally less than 1.00E⁻⁹ cm³·(STP)·cm/cm²·s·bar, when tested under the same conditions.

Suitably, the permeation barrier includes a low permeation polymer matrix includes at least one of PFA, PEEK, PEKK, PTFE, polyketone, ethylene-vinyl alcohol copolymer, polyethylene, polypropylene, PVDF, or PPS.

Suitably, the composite tape layer is a high tortuosity layer as a result of the fibre density in the composite tape of the composite tape layer. Suitably, the fibre density in the composite tape is at least 50% by composite tape cross-sectional area. More suitably, the fibre density is at least 70%, even more suitably at least 80%, by composite tape cross-sectional area. The fibre density of the composite tape may thereby be adjusted only to control the tortuosity of the composite tape layer, without impeding the hoop strength of the flexible pipe body. The fibre density thereby may be adapted to only increase the shielding effect against the fluid permeation, particularly transmission of fluid through the composite tape.

As used herein, the flexible pipe body may be considered unbonded since at least one of the layers of the flexible pipe body is capable of moving longitudinally in relation to the adjacent layers during the bending or flexion of the flexible pipe body. Consequently, the flexible pipe body is bendable and sufficiently flexible to roll up for transportation.

Suitably, the composite tape layer is bonded, or consolidated, to one or more of the sacrificial layers. Suitably, the internal pressure sheath is bonded to the composite tape layer or one of the sacrificial layers.

Suitably, the flexible pipe body further includes one or more layers arranged radially outwardly of the helically wound metallic armour layer, the one or more layers selected from:
at least one tensile armour layer;
an anti-birdcaging tape layer;
an insulation layer;
an outer pressure sheath; and
an outer wear or abrasion layer.

These layers may be provided and arranged in any suitable manner as is known in the art. According to a second aspect of the invention, there is provided a flexible riser comprising a flexible pipe body as described herein.

According to a third aspect of the invention, there is provided a method of manufacturing a flexible pipe body, the method comprising:
providing a composite tape layer for reducing fluid permeation to the armour layer; and
helically winding a metallic armour layer radially outward of the composite tape layer.

By providing such a method of manufacture, an advantageous flexible pipe body as described herein is provided. In particular, the method provides increased flexibility in the design and manufacture of the flexible pipe body. The combination of layers provides the ability to manufacture a flexible pipe body in which the composite tape layer is optimised according to the specific permeation requirements of the production fluids. The permeation of a flexible pipe body is optimised without impeding the hoop strength, and allowing optimisation of the armour layers outside the shielding layer. The permeation of a flexible pipe body is optimised while increasing flexibility.

Suitably, the metallic armour layer is helically wound as one or both of a pressure armour layer and a tensile armour layer.

Suitably, the method further includes extruding an internal pressure sheath. The internal pressure sheath may be positioned radially inward or radially outwards of the composite tape layer.

Suitably, the method further includes providing at least one sacrificial layer radially adjacent the composite tape layer, for instance between a carcass and the composite tape layer. The method provides a flexible pipe body that includes a sacrificial layer positioned radially inward of the composite tape layer. Additionally, or alternatively, the method provides a flexible pipe body including a sacrificial layer positioned radially outward of the composite tape layer. That is, the flexible pipe body may include two sacrificial layers each radially adjacent the composite tape layer such that the composite tape layer is arranged therebetween. The composite tape layer may therefore be sandwiched between two sacrificial layers.

Suitably, the method further includes bonding the composite tape layer to one or more of the sacrificial layers.

Suitably, the method further includes bonding the internal pressure sheath to the composite tape layer.

Suitably, the step of providing the composite tape layer includes providing a plurality of sublayers of composite tape. For example, providing a first composite tape layer and a second composite tape layer.

Suitably, the step of providing the composite tape layer includes winding the composite tape onto the flexible pipe body at a lay angle of less than 80° to the pipe axis. That is, the method includes winding the composite tape onto the flexible pipe body at an angle relative to the longitudinal axis of the flexible pipe body of less than 80°. Suitably, the method step includes winding the composite tape of the composite tape layer at a lay angle relative to the pipe axis of from 20° to less than 80°, more suitably of from 40° to less than 80°. Most suitably the composite tape of the composite tape layer includes a lay angle relative to the pipe axis of from 40° to less than 60°. By reducing the angle of winding the composite tape onto the flexible pipe body, the composite tape layer becomes more flexible. The flexible pipe body including the composite tape layer is thereby also more flexible.

Suitably, the step of providing the composite tape layer includes winding the composite tape with a region of overlap between adjacent wraps, such that each tape wrap at least partially covers a laterally adjacent wrap. The overlaps may therefore reduce permeation of fluids through the composite tape layer by reducing or removing gaps between adjacent tape wraps. Particularly, leakage of fluid via discontinuities between laterally adjacent tape wraps is thereby reduced.

Suitably the method further includes consolidating the composite tape layer with adjacent tape wraps and/or sub-layers of composite tape so the adjacent tapes are at least partially bonded together.

Unless otherwise explicitly stated all features of the invention are considered combinable with one another.

Certain embodiments of the invention provide the advantage that a flexible pipe body with reduced permeation of undesirable fluids and fluids to the pipe annulus may be provided. The resulting annulus environment may therefore be less severe than a conventional flexible pipe body, which can result in increased pipe longevity.

Certain embodiments of the invention allow for a more adaptable composite tape layer to be provided in a flexible pipe body. Such composite tape layers may be more specifically tailored to the intended use of the flexible pipe.

### BRIEF DESCRIPTION OF THE DRAWINGS

Embodiments of the invention are further described hereinafter with reference to the accompanying drawings, in which:

FIG. 1 illustrates a flexible pipe body;

FIG. 2 illustrates a riser system;

FIG. 3 illustrates a cross-sectional view of an example layer arrangement of a flexible pipe body;

FIG. 4 illustrates example composite tape layers wound around an internal pressure sheath with (a) a known example of lay angle and (b) an example lay angle according to the present invention;

FIG. 5 illustrates a cross-sectional view of the composite tape layer of the example arrangement of FIG. 3, including a plurality of sub-layers;

FIG. 6 illustrates a top view of the example winding arrangement of the sub-layers of FIG. 5;

FIG. 7 illustrates a cross-sectional view of an example composite tape layer including a low tortuosity fibre arrangement;

FIG. 8 illustrates a cross-sectional view of an example composite tape layer including

FIG. 9 illustrates a cross-sectional view of a further example layer arrangement of a flexible pipe body;

FIG. 10 illustrates a cross-sectional view of another example layer arrangement of a flexible pipe body;

FIG. 11 illustrates an example method of providing a flexible pipe body;

FIG. 12 illustrates another example method of providing a flexible pipe body; and

FIG. 13 illustrates a further example method of providing a flexible pipe body.

In the drawings like reference numerals refer to like parts.

### DETAILED DESCRIPTION

Certain terminology is used in the following description for convenience only and is not limiting. The words ‘lower’ and ‘upper’ designate directions in the drawings to which reference is made and are with respect to the described component when assembled and mounted. The words ‘inner’, ‘inwardly’ and ‘outer’, ‘outwardly’ refer to directions toward and away from, respectively, a designated centreline or a geometric centre of an element being described (e.g. central axis), the particular meaning being readily apparent from the context of the description.

Further, unless otherwise specified, the use of ordinal adjectives, such as, ‘first’, ‘second’, ‘third’ etc. merely indicate that different instances of like objects are being referred to and are not intended to imply that the objects so described must be in a given sequence, either temporally, spatially, in ranking or in any other manner.

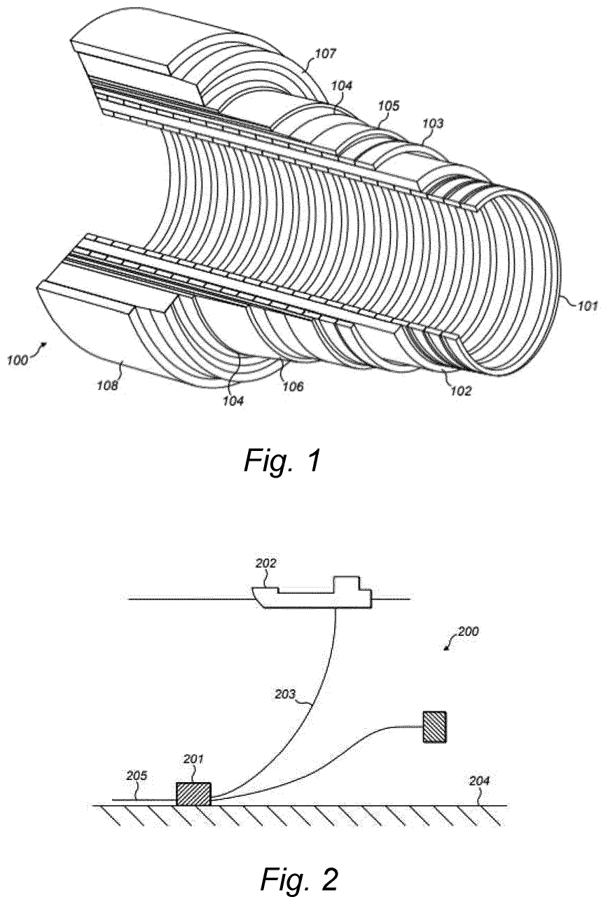

Throughout this description, reference will be made to a flexible pipe. It will be understood that a flexible pipe is an assembly of a portion of flexible pipe body and one or more end fittings in each of which a respective end of the flexible pipe body is terminated. FIG. 1 illustrates how flexible pipe body 100 is formed in accordance with an embodiment from a combination of layered materials that form a pressure-containing conduit. Although a number of particular layers are illustrated in FIG. 1, it is to be understood that the flexible pipe body is broadly applicable to coaxial structures including two or more layers manufactured from a variety of possible materials. For example, the flexible pipe body may be formed from polymer layers, metallic layers, composite layers, or a combination of different materials. It is to be further noted that the layer thicknesses are shown for illustrative purposes only.

While some layers of the flexible pipe body may be described as bonded or consolidated the flexible pipe may generally be considered an unbonded flexible pipe. That is, unless otherwise specified the various layers of the flexible pipe body are unbonded and thereby have the capacity to move longitudinally in relation to the adjacent layers during the bending or flexion of the flexible pipe body.

As used herein, layers may optionally include sublayers. A plurality of sublayers cooperate to form a layer with a specific purpose. For example, a tape composite layer may be formed of one or more sublayers.

As used herein, a composite refers to a material that is formed from two or more different materials, for example a material formed from a matrix material and reinforcement fibres. In some examples, a composite may be a composite tape layer. In other examples a composite may include an extruded layer. Fibres within a composite material may include any of carbon fibres, or glass fibres, or basalt fibres, or tensilized polymer fibres, or metal wires, or any combination thereof. Fibres may be long or short in order to optimise or utilise their strength in one or many directions in the composite material. Long, continuous fibres are typically taken as being primarily orientated in one particular direction in order to provide strength to the composite in that orientation.

As used herein, a tape is to be broadly construed as encompassing any elongate structure having a preformed cross section that can be wound in a helical manner around an underlying structure. That is, a tape refers to an elongate material provided in a wrapable or windable form, so as to form a layer by winding around a radially inward layer of the flexible pipe body. In particular, a composite tape is a wrapable or windable elongate composite material which is used to form a composite tape layer.

As used herein the term lay angle refers to the angle at which a tape or layer is applied to, that is wrapped around, an underlying structure of the flexible pipe body. The lay angle is thereby an angle relative to the longitudinal axis of the flexible pipe body. A tape with lay angle of 90° would be a tape wrapped around a radius of a cross-section of the flexible pipe body (perpendicular to the longitudinal axis of the pipe).

It will be understood that the term ‘radially’ is used to refer to a position in relation to the radius of the flexible pipe body. For example, the term ‘radially inward’ is intended to refer to a position which is relatively closer to the centre, or central longitudinal axis, of the flexible pipe body and ‘radially outward’ is intended to refer to a position which is relatively more distant from the centre, or axis, of the flexible pipe body.

Referring now to FIG. 1, a traditional layer arrangement of flexible pipe body 100 is illustrated. In this example the flexible pipe body 100 includes an optional innermost carcass layer 101. The carcass layer 101 provides an interlocked construction that can be used as the innermost layer to prevent, totally or partially, collapse of an internal pressure sheath 102 due to pipe decompression, external pressure, and tensile armour pressure and mechanical crushing loads. The carcass layer 101 is often a metallic layer, formed from stainless steel, for example. The carcass layer could 101 also be formed from composite, polymer, or other material, or a combination of materials. It will be appreciated that certain embodiments are applicable to ‘smooth bore’ operations (i.e. without a carcass layer) as well as such ‘rough bore’ applications (with a carcass layer).

The internal pressure sheath 102 acts as a fluid retaining layer and includes a polymer layer that ensures internal fluid integrity. It is to be understood that this layer may itself comprise a number of sub-layers. It will be appreciated that when the optional carcass layer 101 is utilised the internal pressure sheath 102 is often referred to by those skilled in the art as a barrier layer. In operation without such a carcass layer 101 (so-called smooth bore operation) the internal pressure sheath 102 may be referred to as a liner.

An optional sacrificial or wear layer may also be added, as an extruded layer or helically wound tape layer. The optional sacrificial or wear layer may be either or both radially inwardly or radially outwardly of the internal pressure sheath. The sacrificial layer(s) thereby provide a relatively smooth (compared to the outside surface of the carcass layer) surface over which to extrude the internal pressure sheath. Additionally, or alternatively, the sacrificial layer(s) thereby provide a sacrificial layer of material which may, under pressure, creep into the gaps between wraps of an overlying metallic armour layer, particularly a pressure armour layer.

An optional pressure armour layer 103 is provided radial outward of the internal pressure sheath 102. The pressure armour layer 103 is a structural layer that increases the resistance of the flexible pipe to internal and external pressure and mechanical crushing loads. That is, the pressure armour layer 103 sustains radial loads. The pressure armour layer 103 specifically provides hoop strength to the flexible pipe body 100.

The pressure armour layer 103 also structurally supports the internal pressure sheath 102. Referring additionally to FIG. 4(a), the pressure armour layer 103 is formed from an interlocked construction of wires wound with a lay angle a relative to a flexible pipe body axis A-A. The lay angle a is typically close to 90°. In this way laterally adjacent interlocking wires provide a rigid pressure armour layer 103 that provides maximal hoop strength to the entire flexible pipe body 100.

The flexible pipe body 100 as shown includes sub-layers including a first tensile armour layer 105 and second tensile armour layer 106. Each tensile armour layer is used to sustain tensile loads and internal pressure and are wound at angles around the pipe body optimised to achieve the desired balance of tensile and pressure containment. For instance, the lay angle of the tensile armour wires may be around +/−55° when no pressure armour wire is used in the design (and the tensile armours must withstand both pressure and tension forces), however their lay angles may be much lower, for instance as low as 27° to 30° when a radially inward pressure armour is incorporated with a lay angle of close to 90° and the tensile armour layers are primarily intended to sustain tensile loads. Each tensile armour layer is formed from a plurality of wires (to impart strength to the layer) that are located over an inner layer and are helically wound along the length of the pipe. The tensile armour layers are often counter-wound in pairs. The tensile armour layers are often metallic layers, formed from carbon steel, for example.

The flexible pipe body 100 shown also includes optional tape layers 104 provided radially outward of the tensile armour layers 105, 106, which help contain underlying layers and extent prevent abrasion between adjacent layers.

The flexible pipe body 100 also typically includes optional layers of insulation 107 and an outer sheath 108, which includes a polymer layer used to protect the pipe against penetration of seawater and other external environments, corrosion, abrasion and mechanical damage. Further layers (not shown) may also be added radially outside the outer sheath 108 to provide additional wear/abrasion protection to the pipe and to prevent damage from occurring to the outer sheath 108.

Each flexible pipe 100 includes at least one portion, sometimes referred to as a segment or section of flexible pipe body 100 together with an end fitting located at at least one end of the flexible pipe. An end fitting provides a mechanical device which forms the transition between the flexible pipe body and a connector. The different pipe layers as shown, for example, in FIG. 1 are terminated in the end fitting in such a way as to transfer the load between the flexible pipe body and the connector.

Referring now to FIG. 2, there is shown a known riser assembly 200 suitable for transporting production fluid such as oil and/or gas and/or water from a sub-sea location 201 to a floating facility. For example, in FIG. 2 the sub-sea location 201 includes a sub-sea flow line. The flexible flow line 205 includes a flexible pipe 203, wholly or in part, resting on the sea floor 204 or buried below the sea floor and used in a static application. The floating facility may be provided by a platform and/or buoy or, as illustrated in FIG. 2, a ship 200. The riser assembly 200 is provided as a flexible riser, that is to say a flexible pipe 203 connecting the ship to the sea floor installation. The flexible pipe 203 may be in segments of flexible pipe body with connecting end fittings.

It will be appreciated that there are different types of riser, as is well-known by those skilled in the art. Embodiments may be used with any type of riser, such as a freely suspended (free, catenary riser), a riser restrained to some extent (buoys, chains), totally restrained riser or enclosed in a tube (I or J tubes). FIG. 2 also illustrates how portions of flexible pipe body can be utilised as a flow line 205 or jumper.

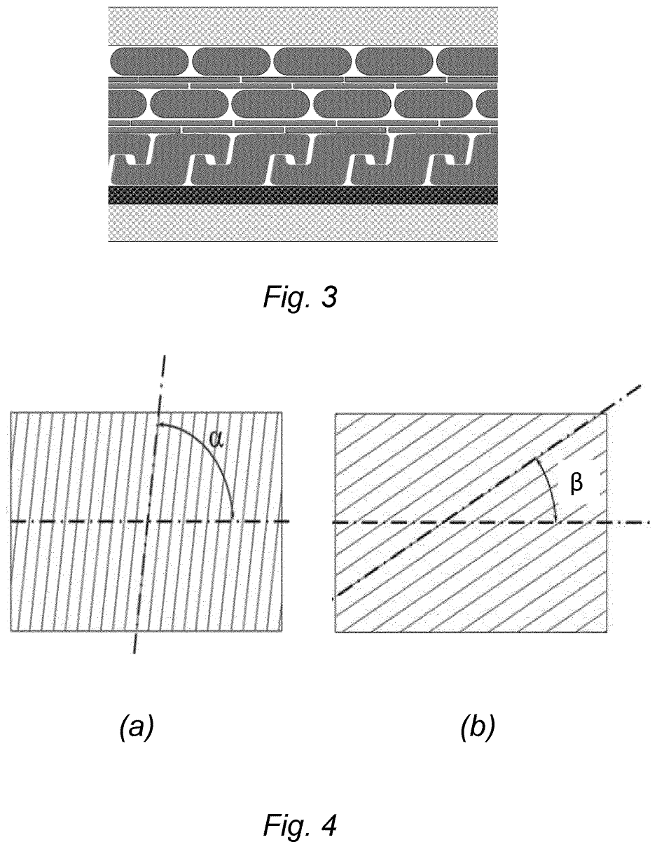

Referring now to FIG. 3 an example layer arrangement of a flexible pipe body 300 is shown in cross-section. In this example, the flexible pipe body 300 includes an internal pressure sheath 302. The internal pressure sheath 302 defines the flexible pipe bore. In some examples a carcass layer (not shown) may be provided radially inward of the internal pressure sheath 302 to define the pipe bore.

Tape layers (not numbered), tensile armour layers 305, 306 and an outer sheath 308 are provided in the radially outer portion of the flexible pipe body 300. These layers are described above with reference to FIG. 1 and so will not be described again for brevity. Although not illustrated one or more insulating layers, and/or abrasion-resistant layers, as is known in the art, may also be included in the flexible pipe body 300.

In the example shown, the flexible pipe body 300 in this example includes a pressure armour layer 303. The pressure armour layer 303 is a helically wound pressure layer.

The pressure armour layer 303 includes pressure armour wires. The pressure armour wires are wrapped or wound around a composite tape layer 310 to form the pressure armour layer 303. Successive pressure armour wires are wrapped around the composite tape layer 310 to provide a region of overlap between laterally adjacent wire windings.

The pressure armour layer 303 has an interlocked construction. Each pressure armour wire includes axially opposed edges 303a, 303b including mutually engaging features, as is known in the art. In this way, laterally adjacent wire windings of the pressure armour layer 303 interlock in the region of overlapping edges 303a, 303b. In this way, the pressure armour layer 303 predominantly provides the hoop strength for the flexible pipe body 300.

The pressure armour layer 303 is provided radially outward of the internal pressure sheath 302.

The flexible pipe body 300 includes a composite tape layer 310 positioned radially inward of the pressure armour layer 303. In the example shown, the composite tape layer 310 is provided between the internal pressure sheath 302 and the pressure armour layer 303. The internal pressure sheath 302 is positioned radially inwards of the composite tape layer.

It will be understood that for flexible pipes of design where no interlocked pressure armour is needed, such that the tensile armour layers provide both pressure and tension reinforcement for the pipe, then the pressure armour layer 303 shown in FIG. 3 may be omitted.

Referring additionally to FIG. 4(b), the composite tape layer 310 is formed of a composite tape wound onto the internal pressure sheath 302. The composite tape layer 310 is configured to reduce fluid permeation therethrough. In the example shown, the composite tape layer 310 includes a lay angle β relative to an axis B-B of the flexible pipe body 300. In the example shown the lay angle β is 40° to the axis B-B of the flexible pipe body 300. The reduced lay angle β therefore can lead to a reduced minimum bending radius of the composite tape layer (without risking damage, delamination or cracking of the composite tapes). Consequently, the lower minimum bending radius allows for greater flexibility of the flexible pipe body.

The composite tape layer 310 includes composite tape wrapped or wound around an internal pressure sheath 302 to form the composite tape layer 310. Successive wraps of composite tape are wrapped or wound around the composite tape layer 310 to provide a region of overlap between laterally adjacent wire windings.

The composite tape layer 310 includes a region of overlap between laterally adjacent tape wraps. In this way, a first tape wrap overlaps a laterally adjacent second tape wrap. Each tape wrap at least partially covers a laterally adjacent second tape wrap. The overlaps may therefore reduce permeation of fluids through the composite tape layer by reducing or removing gaps between adjacent tape wraps which could otherwise provide leakage paths. The composite tape layer 310 includes a plurality of long fibres. The plurality of long fibres in the composite tape of the composite tape layer 310 are continuous fibres, such as those disclosed herein.

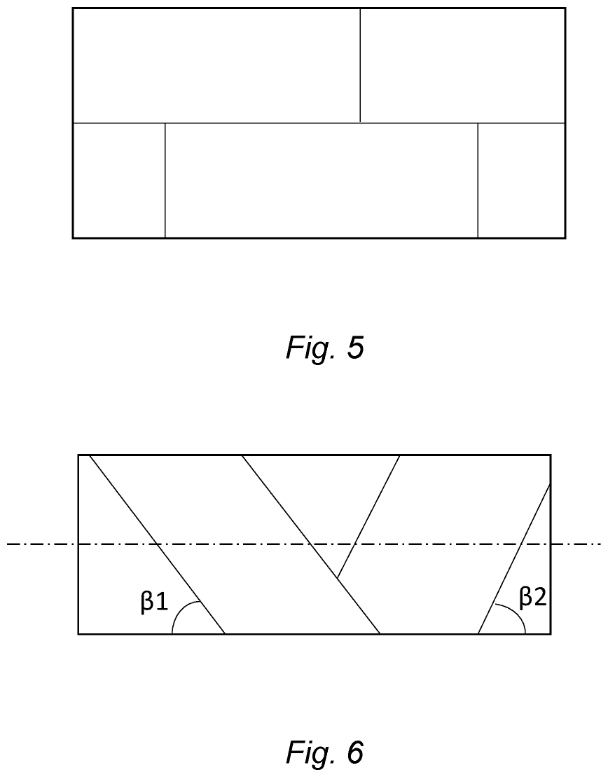

The continuous fibres are aligned in the length direction of the composite tape. That is, the continuous fibres are aligned longitudinally within the composite tape. With the composite tape wound around the internal pressure sheath 302 the continuous fibres of the composite have a lay angle substantially the same as the lay angle β of the composite tape layer 310. Referring now to FIGS. 5 and 6, there are shown close-up views of the composite tape layer 310 of FIG. 3. The composite tape layer 310 includes a first sub-layer 310a of composite tape and a second sub-layer 310b of composite tape. The first sub-layer 310a is provided radially outward of the second sub-layer 310b.

In the example shown, the first sub-layer 310a is consolidated with the second sub-layer 310b. In this way the sub-layers are substantially bonded together to form a single composite tape layer 310. The sub-layers thereby function collectively as a composite tape layer 310 to reduce fluid permeation within the flexible pipe body 300, as is described herein.

The composite tapes of each of the first sub-layer 310a and the second sub-layer 310b have the properties of the composite tape as described herein. One or more properties of the composite tape of the first sub-layer 310a may be different to one or more corresponding property of the second sub-layer 310b.

The first sub-layer 310a is wound at a first lay angle β1 to the axis of the flexible pipe body 300. The second sub-layer 310b is counter wound at a second lay angle β2 to the axis of the flexible pipe body 300. In this way permeation of fluids through the composite tape layer 310 is reduced by removing gaps, or discontinuities, between successive wraps of composite tape sub-layers 310a, 310b that may otherwise provide leakage pathways.

In use, a flexible pipe body 300 including the example composite tape layer 310 described above may be provided with suitable connectors to enable the flexible pipe body to form a flexible pipe for transporting production fluid, such as described with reference to FIG. 2. By providing a layer arrangement as described with reference to FIG. 3, a flexible pipe body with reduced permeation of undesirable fluids to the pipe annulus may be provided.

Advantageously, by forming the composite tape layer 310 from two (or more) sub-layers 310a, 310b a greater number of options for design and manufacture of the flexible pipe body 300 is provided. The consolidation of sub-layers provides the ability to adapt the composite tape layer 310 according to the specific permeation requirements of the production fluids contained within the flexible pipe body 300. For example, a first sub-layer may preferentially block permeation, that is transmission, of a first production fluid, and a second sub-layer may preferentially block permeation, that is transmission, of a second production fluid.

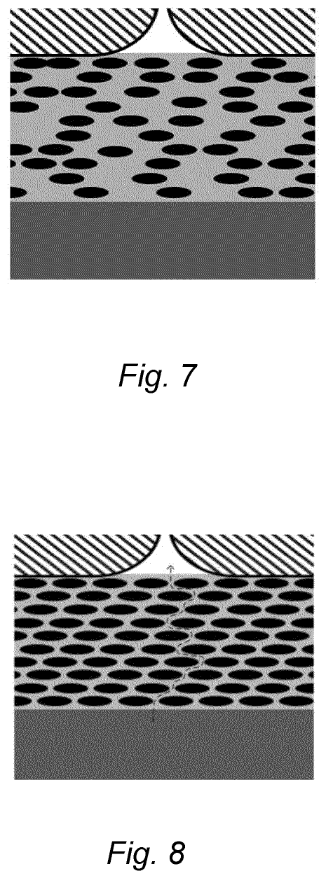

Referring now to FIG. 7, there is shown a schematic example of a composite tape layer 710 in which the fibre density provides a low tortuosity layer. The fibres 712 of the composite tape layer 710 are impermeable such that permeation of fluid through occurs by permeating the matrix 714 in which the fibres 712 are embedded.

In the example shown, the fibre density of the composite tape layer 710 is substantially less than 50%. That is, the composite tape layer 710 has a low fibre density. Typically, a low fibre density may be as a result of the use of fibre bundles with relatively large gaps between the bundles, where matrix material is predominantly or exclusively present. Consequently, there is a low tortuosity as fluid permeation through the composite tape layer 710 occurs via a relatively short tortuous path. The fibre density is sufficiently low that the composite tape layer 710 would be subject to fluid permeation, particularly transmission, such that a flexible pipe body including the composite tape layer 710 would fall outside the technical requirements for safe pipes.

Referring now to FIG. 8, there is shown a schematic example of a composite tape layer 810 in which the fibre density provides a high tortuosity layer. The composite tape layer is made up of a polymer matrix 814 and composite fibres 812 to provide sufficient fibre density such that fluid permeation occurs via a relatively long tortuous path 819.

In the example shown, the fibre density of the composite tape layer 810 is substantially greater than 50%. A permeation coefficient for CO₂ is thereby provided of less than 50.00E-6cm³·(STP)·cm/cm²·s·bar, when tested at 100°C., 8 bar pressure in accordance with ISO 2556 and ISO 15105-1. The composite tape layer 810 thereby significantly reduces fluid permeation into the flexible pipe annulus. Consequently, the likelihood of stress corrosion cracking and sulfide stress cracking is reduced.

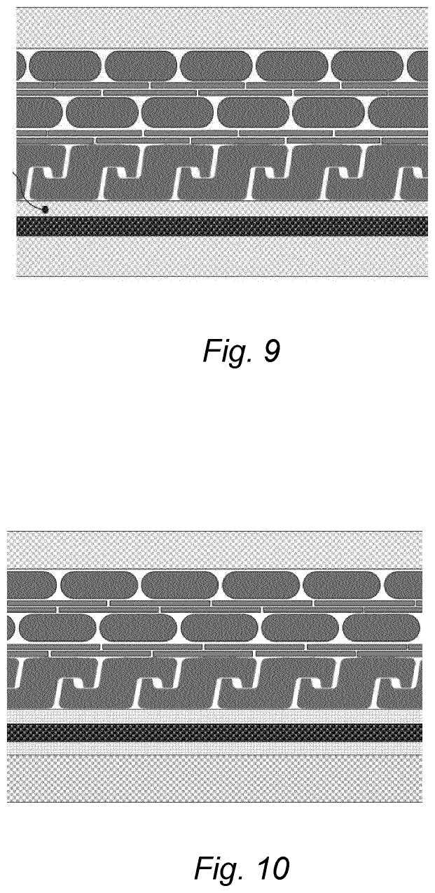

Referring now to FIG. 9, there is shown another example layer arrangement of a flexible pipe body 900. The layer arrangement is substantially the same as the arrangement described with reference to FIG. 3 other than the flexible pipe body 900 includes a sacrificial layer 912 radially adjacent to the composite tape layer 910.

Tape layers, tensile armour layers 905, 906 and an outer sheath 908 are also provided. These layers are substantially as described herein with reference to FIG. 1 and so will not be described again for brevity.

In the example shown, the sacrificial layer 912 is provided radially outwards of the composite tape layer 910.

The composite tape layer 910 is bonded to the sacrificial layer 912. In the example shown, the composite tape layer 910 and the sacrificial layer 912 are at least partially bonded to one another using an adhesive. Alternatively, the composite tape layer and the sacrificial layer may be at least partially bonded to one another using a melt consolidation or a melt bond, using heat and/or pressure from rollers. A melt consolidation or a melt bond is a bond without an adhesive.

The sacrificial layer 912 is thereby located between the pressure armour layer 903 and the composite tape layer 910. This therefore prevents direct contact of the composite tape layer 910 and the pressure armour layer 903. The sacrificial layer 912 will protect the composite tape layer 910 from damage caused by the pressure armour layer 903 should they come into contact. The use of the sacrificial layer 912 prevents local strain. The use of the sacrificial layer 912 prevents the composite tape layer 910 from being affected by the gaps within the pressure armour layer 903.

Referring now to FIG. 10, there is shown a further example layer arrangement of a flexible pipe body 1000. The layer arrangement is substantially the same as the arrangement described with reference to FIG. 9 other than the flexible pipe body 1000 includes two sacrificial layers radially adjacent to the composite tape layer 1010.

Tape layers, tensile armour layers 1005, 1006 and an outer sheath 1008 are also provided. These layers are substantially as described herein with reference to FIG. 1 and so will not be described again for brevity.

In the example shown, a first sacrificial layer 1012a is provided radially outwards of the composite tape layer 1010 and a second sacrificial layer 1012b is provided radially inwards of the composite tape layer 1010.

In this example, the flexible pipe body 1000 includes an internal pressure sheath 1002. The internal pressure sheath 1002 defines the flexible pipe bore. Optionally, a carcass layer (not shown) may be provided radially inward of the internal pressure sheath 1002 to define the pipe bore.

Additionally, the example includes a pressure armour layer 1003, a composite tape layer 1010 and a first sacrificial layer 1012a located between the composite tape layer and the pressure armour layer as described above in FIG. 9.

The second sacrificial layer 1012b is provided radially adjacent to the composite tape layer 1010. In particular, the second sacrificial layer 1012b is provided radially inward of the composite tape layer 1010. The two sacrificial layers protect the composite tape layer 1010 from damage from the pressure armour layer 1003 and from the internal pressure sheath 1002. The two sacrificial layers may also each provide a shielding effect which acts as a further permeation resistance feature for fluids coming from the production fluids. The two sacrificial layers may be applied as extrusions, or as helically wound tapes of suitable polymer material, either consolidated or left unconsolidated.

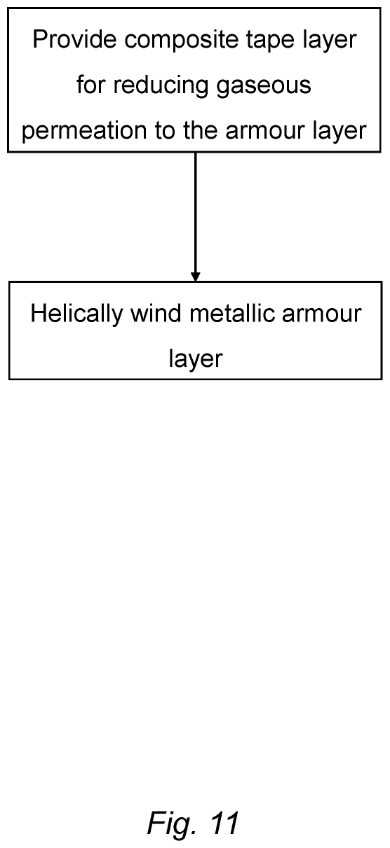

Referring now to FIG. 11, there is shown a flow chart illustrating a method 1100 of manufacturing a flexible pipe body, such as those described herein. The method may be carried out using any suitable choice of operation such as mechanically or manually winding the layers.

A first step 1120 includes providing a composite tape layer for a flexible pipe body for reducing fluid permeation through the flexible pipe body. The composite tape layer thus reduces fluid permeation from production fluids transported within the bore of the internal pressure sheath to the pressure armour layer.

The composite tape layer is wound onto the flexible pipe body. The composite tape layer is wound onto the flexible pipe body at a lay angle of less than 80° to the flexible pipe body axis. In this way the structure of the composite tape layer will be flexible. The composite tape layer will also have fewer gaps between layers to effectively reduce fluid permeation through the layer, particularly through leakage, and into the pipe annulus.

Optionally, the composite tape layer may be provided on the flexible pipe body as a plurality of sub-layers which overlap with one another. In this way, first and second sub-layers are wound sequentially onto the flexible pipe body.

A second step 1140 includes helically winding a metallic armour layer radially outward of the composite tape layer. In this way, the method provides the metallic armour layer to predominantly provide the hoop strength for the flexible pipe body.

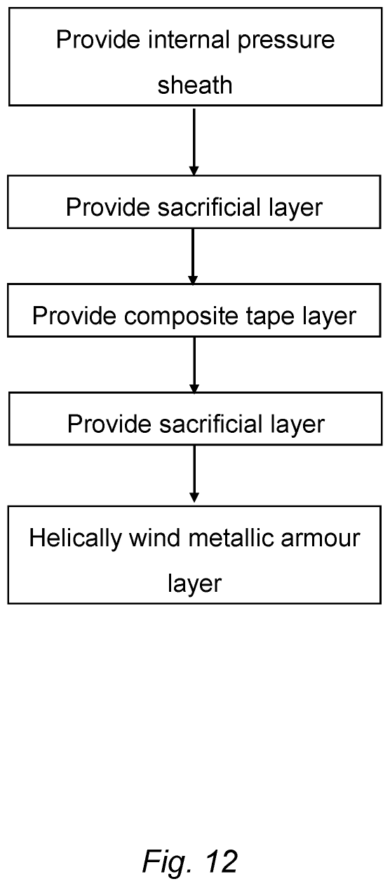

Referring now to FIG. 12, there is shown a flow chart illustrating another method 1200 of manufacturing a flexible pipe body. The method is substantially the same as the method 1100 described with reference to FIG. 11 other than sacrificial layers are additionally provided. The method maybe carried out using any suitable choice of operation such as mechanically or manually winding the layers.

A first step 1210 includes providing an internal pressure sheath for the flexible pipe body. Suitably, the internal pressure sheath is formed by an extrusion process as is known in the art.

A second step 1215 includes providing a sacrificial layer radially adjacent to the composite tape layer. The sacrificial layer prevents direct contact between the composite tape layer and the internal pressure sheath. Damage to the internal pressure sheath that could be caused by such contact, or from heat applied during the manufacturing consolidation process for the composite tape layer, is prevented. The sacrificial layer additionally has some shielding properties which further reduce permeation through the flexible pipe body. A third step 1220 includes providing a composite tape layer. The composite tape is configured to reduce fluid permeation to a pressure armour layer of the flexible pipe, as has been described herein.

The composite tape may be wound on as referred in first step 1120 of the method described with reference to FIG. 11. By providing the composite tape layer after the sacrificial layer, the method ensures that the composite tape layer is radially adjacent to the sacrificial layer.

A fourth step 1230 includes providing a second sacrificial layer. The second sacrificial layer is provided radially adjacent to, in this case radially outward to, the composite tape layer. The second sacrificial layer protects the composite tape layer from any damage and strain that can be caused by the composite layer coming into contact with the metallic armour layer. The second sacrificial layer may also help to reduce fluid permeation through the flexible pipe body.

A fifth step 1240 includes helically winding a metallic armour layer radially outward of the composite tape layer. In this way, the method provides the metallic armour layer to predominantly provide hoop strength for the flexible pipe body.

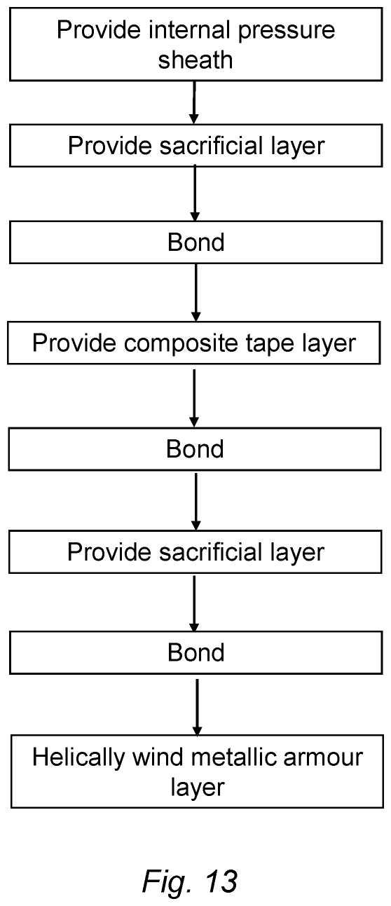

Referring now to FIG. 13, there is shown a flow chart illustrating a further method 1300 of manufacturing a flexible body. The method is substantially the same as the method 1200 described with reference to FIG. 12 other certain layers of the flexible pipe body are additionally bonded to radially adjacent layers.

Thus, a first step 1310 includes providing an internal pressure sheath of the flexible pipe. Optionally the internal pressure sheath is provided over a carcass layer (not shown).

A second step 1315 includes providing a sacrificial layer radially adjacent to the composite tape layer as described in the corresponding step 1240 of the method of FIG. 12.

A third step 1318 includes bonding the sacrificial layer to the internal pressure sheath. In the example shown, the internal pressure sheath and the sacrificial layer are at least partially bonded to one another using an adhesive. Alternatively, the composite tape layer and the sacrificial layer may be at least partially bonded to one another using a melt consolidation or a melt bond, using heat and/or pressure from rollers. A melt consolidation or a melt bond is a bond without adhesive.

A fourth step 1320 includes providing a composite tape layer. This may be wound onto the flexible pipe body as described with reference to the methods above.

A fifth step 1328 includes bonding the composite tape layer to the sacrificial layer.

A sixth step 1330 includes providing a second sacrificial layer radially adjacent to the composite tape layer as described in the corresponding step 1280 of the method of FIG. 12. A seventh step 1338 includes bonding the composite tape layer to the second sacrificial layer. This provides additional permeation resistance and protects the composite tape layer from damage caused by contact with the pressure armour layer.

An eighth step 1340 includes helically winding a metallic armour layer radially outward of the composite tape layer. In this way, the method provides the metallic armour to at least partially provide hoop strength for the flexible pipe body.

It will be clear to a person skilled in the art that features described in relation to any of the embodiments described above can be applicable interchangeably between the different embodiments. The embodiments described above are examples to illustrate various features of the invention.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise. It will be also be appreciated that, throughout this specification, language in the general form of “X for Y” (where Y is some action, activity or step and X is some means for carrying out that action, activity or step) encompasses means X adapted or arranged specifically, but not exclusively, to do Y.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A flexible pipe body for transporting production fluids, the flexible pipe body comprising:
a helically wound metallic armour layer; and
a composite tape layer for reducing fluid permeation of the production fluids to a pipe annulus, wherein the composite tape layer comprises a plurality of fibres;
wherein the composite tape layer is positioned radially inward of the helically wound metallic armour layer.

2. The flexible pipe body according to claim 1, further comprising an internal pressure sheath, wherein the internal pressure sheath is positioned radially inward of the composite tape layer.

3. The flexible pipe body according to claim 1, further comprising an internal pressure sheath, wherein the internal pressure sheath is positioned radially outward of the composite tape layer.

4. The flexible pipe body according to claim 1, wherein the flexible pipe body comprises at least one sacrificial layer radially adjacent to the composite tape layer.

5. The flexible pipe body according to claim 4, wherein the flexible pipe body comprises two sacrificial layers each radially adjacent to the composite tape layer such that the composite tape layer is arranged therebetween.

6. The flexible pipe body according to claim 1, wherein the plurality of fibres in the composite tape layer are continuous fibres.

7. The flexible pipe body according to claim 6, wherein the continuous fibres are aligned in the length direction of the composite tape.

8. The flexible pipe body according to claim 1, wherein the plurality of fibres in the composite tape layer comprise carbon fibres, glass fibres, basalt fibres, tensilized polymer fibres, metal wires, or any combination thereof.

9. The flexible pipe body according to claim 1, wherein the composite tape of the composite tape layer comprises a lay angle relative to an axis of the flexible pipe body of less than 80°.

10. The flexible pipe body according to claim 1, wherein the composite tape layer comprises a plurality of sub-layers of composite tape.

11. The flexible pipe body according to claim 1, wherein the composite tape layer comprises a region of overlap between adjacent composite tape wraps, such that each composite tape wrap at least partially covers a laterally adjacent composite tape wrap.

12. The flexible pipe body according to claim 11, wherein the composite tape layer is consolidated with adjacent composite tape wraps and/or sub-layers of composite tape so the adjacent tapes are at least partially bonded together.

13. The flexible pipe body according to claim 10, wherein the plurality of sub-layers comprise different lay angles from each other.

14. The flexible pipe body according to claim 1, wherein the composite tape layer is less than 5 mm thick.

15. The flexible pipe body according to claim 1, wherein the composite tape layer comprises a low permeation polymer matrix with a permeation coefficient for CO₂ of less than 50.00E-6cm³·(STP)·cm/cm²·s·bar.

16. The flexible pipe body according to claim 1, wherein the composite tape layer is a high tortuosity layer as a result of a fibre density in the composite tape of the composite tape layer being at least 50% by composite tape cross-sectional area.

17. The flexible pipe body according to claim 1, wherein the composite tape layer is bonded to one or more of the sacrificial layers.

18. The flexible pipe body according to claim 2, wherein the internal pressure sheath is bonded to the composite tape layer or one of the sacrificial layers.

19. The flexible pipe body to claim 1, wherein the pipe further comprises one or more layers arranged radially outwardly of the helically wound metallic armour layer, the one or more layers being selected from:
at least one tensile armour layer;
an anti-birdcaging tape layer;
an insulation layer;
an outer pressure sheath; and
an outer wear or abrasion layer.

20. A flexible riser comprising the flexible pipe body of claim 1.

21. A method of manufacturing a flexible pipe body, the method comprising:
providing a composite tape layer for reducing fluid permeation to a metallic armour layer; and
helically winding the metallic armour layer radially outward of the composite tape layer.

22. The method of claim 21, further comprising a step of extruding an internal pressure sheath, wherein the internal pressure sheath is positioned radially inward of the composite tape layer.

23. The method of claim 21, further comprising a step of providing at least one sacrificial layer radially adjacent the composite tape layer.

24. The method according to claim 23, further comprising a step of bonding the composite tape layer to one or more of the sacrificial layers.

25. The method according to claim 22, further comprising a step of bonding the internal pressure sheath to the composite tape layer.

26. The method according to claim 21, wherein providing the composite tape layer comprises providing a plurality of sub-layers of composite tape.

27. The method according to claim 21, wherein providing the composite tape layer comprises winding the composite tape onto the flexible pipe body at a lay angle of less than 80° to the pipe axis.

28. The method according to claim 21, wherein providing the composite tape layer comprises winding the composite tape with a region of overlap between laterally adjacent composite wraps, such that each composite tape wrap at least partially covers the laterally adjacent composite tape wrap.

29. The method according to claim 28, further comprising a step of consolidating the composite tape layer with laterally adjacent composite tape wraps and/or sub-layers of composite tape, using heat and/or pressure, so that the adjacent tapes are at least partially bonded together.
